(19) United States
(12) Patent Application Publication
(10) Pub. No.: US 2011/0113007 A1
(43) Pub. Date: May 12, 2011

(54) Flex Computing End-User Profiling

(76) Inventor: Richard Buckley, Berkshire (GB)

(21) Appl. No.: 12/616,841

(22) Filed: Nov. 12, 2009

(51) Int. Cl. G06F 17/30; G06F 15/16; G06N 5/02

(52) U.S. Cl. 707/607; 709/224; 707/749; 707/E17.005; 707/E17.009; 707/802; 707/780; 706/47

(57) ABSTRACT

A system and method are disclosed for automatically providing a usage profile corresponding to a user of a plurality of information handling system resources. Survey information related to a user of IHS resources is collected and processed to generate survey information. IHS resources used by the user are determined and associated configuration and operational information is collected and processed to generate imported information. The survey information and the imported information are then processed to generate a set of user usage scores, which are in turn processed to produce a user usage model, which is likewise processed to generate a user usage fingerprint. Comparison operations are performed between the user usage fingerprint and a plurality of reference usage profiles and the reference usage profile most closely matching the user usage fingerprint is selected. Sizing, return on investment (ROI) and total cost of ownership (TCO) calculations are performed related to associating the user with the selected reference usage profile.

### BACKGROUND OF THE INVENTION

1. Field of the Invention

The present invention relates to the management of information handling systems. More specifically, embodiments of the invention provide a system and method for automatically providing a usage profile corresponding to a user of a plurality of information handling system resources.

2. Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

However, the growing number, complexity, and diversity of these systems poses significant challenges to today's information technology (IT) executive, not the least of which is choosing the right technology and deployment options for their organization. Another challenge is providing users an optimum system configuration, which includes not only computing hardware, but operating system, software applications, network connectivity, and effective access to the information resources they require to be productive. In the past, a “one size fits all” approach was taken in an attempt to simplify deployment and minimize support issues. However, such approaches resulted in some users being allocated insufficient resources while resources allocated to other users were underutilized or not used at all.

Attempts to address this issue have often included having a relatively small number of standardized system, application, and connectivity configurations. More recent approaches have included virtualization, where physical resources are collectively managed as virtual machines, each assigned to specific users or applications. These efforts have been facilitated with the advent of technologies such as storage area networks (SANs), where large volumes of storage are networked together and accessed by a network connection. In parallel, advances in network technologies allow high-speed access to data, even from mobile devices.

More recently, the concept of flex computing has come into vogue. Flex computing allows a computing environment to be custom-tailored to the needs of individual users. As their needs change, the computing environment can be adjusted to adapt to changing requirements. However, the fundamental issue persists. Custom-configuring a flex computing environment for an individual user, while attractive, can often be more complex than configuring physical resources. As a result, it is not uncommon for IT managers to revert to standardizing on a handful of flex computing configurations, assigning users to the configuration that appear to most closely match their needs. In addition, the implementation and deployment of flex computing environments currently rely on manual processes, which are time-consuming, costly, and error-prone. In view of the foregoing, there is a need for automatically determining the specific needs of users and their corresponding use of information handling system resources, especially in large, complex, and diverse environments. Once those needs are determined, there is a further need for automatically providing the information handling system resources that are required to support their needs.

### SUMMARY OF THE INVENTION

A system and method are disclosed for automatically providing a usage profile corresponding to a user of a plurality of information handling system resources. In various embodiments, survey information related to a user of IHS resources is collected and then processed by a survey module to generate survey information. IHS resources used by the user are determined and associated configuration and operational information is collected. In various embodiments, the configuration information and the operational information are automatically collected by a remote management system. In these and various other embodiments, the configuration information related to the IHS resources is stored in a Configuration Management Database (CMDB). In one embodiment, the automatically collected configuration information and operational information is provided by the remote management system to an import module. Once provided, the collected configuration information and operational information is processed by the import module to generate imported information.

The survey information and the imported information are then processed by a scoring module to generate a set of user usage scores, which are in turn processed by the scoring module to produce a user usage model. The resulting user usage model is then likewise processed by the scoring module to generate a user usage fingerprint. Comparison operations are then performed between the user usage fingerprint and a plurality of reference usage profiles by a comparison and weighting module. The reference usage profile most closely matching the user usage fingerprint is then selected. If the user is not currently associated with the selected reference usage profile, then a usage weighting value is calculated. In one embodiment, the usage weighting value is proportionate to the difference between the user usage fingerprint and the selected reference usage profile. A determination is then made whether the usage weighting value is within predetermined usage limits. If so, then sizing, return on investment (ROI) and total cost of ownership (TCO) calculations are performed by an assessment module, using a rules service module, a decision analytics module, an online transaction processing (OLTP) module, and information provided by an operational data store (ODS).

In various embodiments, the decision analytics module processes the operational information provided by the ODS to generate rules queries and to perform analysis operations related to the user's use of the IHS resources. The OLTP module likewise processes the operational information to generate rules queries and to perform rules processing transactions in various embodiments. In these and other embodiments, the rules service module receives requests for a rules query, submits the rules query to a rules engine, receives the results of the rules query from the rules engine, and provides the results of the rules query to the requestor. In various embodiments, the rules engine comprises a plurality of rules referenced to a business object model (BOM). In one embodiment, the BOM comprises an extensible markup language (XML) schema. If a decision is made to associate the user with the selected reference usage profile, then a provisioning module is used to perform associated provisioning operations. Once the provisioning operations are completed, a sizing, ROI, and TCO report reflecting the association is generated by a document generation module.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 is a general illustration of components of an information handling system as implemented in the system and method of the present invention;

FIG. 2 is a simplified block diagram of an automated usage profiling system as implemented in accordance with an embodiment of the invention;

FIG. 3 is a simplified block diagram illustrating a remote management system as implemented in accordance with an embodiment of the invention;

FIGS. 4a-b are a simplified block diagram of a plug-in module of a service delivery platform as implemented in accordance with an embodiment of the invention;

FIG. 5 is a simplified process flow diagram of the operation of an automated usage profiling system as implemented in accordance with an embodiment of the invention to generate reference usage profile recommendations;

FIG. 6 is a simplified block diagram of the automated generation of a user usage score as implemented in accordance with an embodiment of the invention to generate a corresponding user usage model;

FIG. 7 is a simplified block diagram of a user usage model as implemented in accordance with an embodiment of the invention to generate a corresponding user usage fingerprint;

FIG. 8 is a simplified block diagram of a fingerprinting system as implemented in accordance with an embodiment of the invention to determine a reference usage profile most closely matching an individual user usage fingerprint; and

FIGS. 9a-e are a flow chart of the operation of an automated usage profiling system as implemented in accordance with an embodiment of the invention to generate user usage fingerprints.

### DETAILED DESCRIPTION

A system and method are disclosed for automatically providing a usage profile corresponding to a user of a plurality of information handling system resources. For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

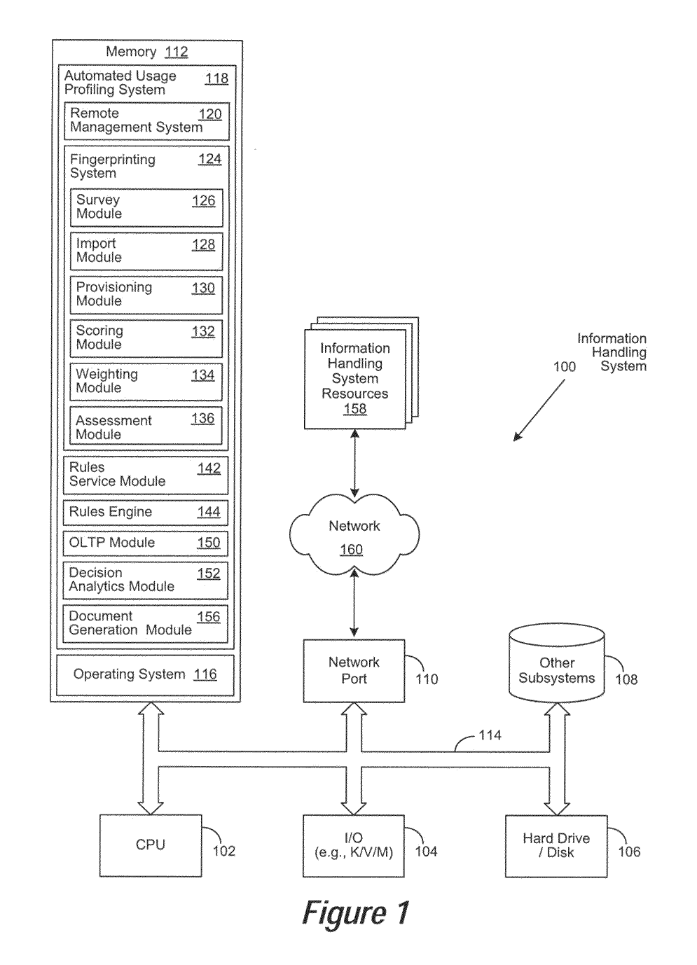

FIG. 1 is a generalized illustration of an information handling system 100 that can be used to implement the method and system of the present invention. The information handling system 100 includes a processor (e.g., central processor unit or “CPU”) 102, input/output (I/O) devices 104, such as a display, a keyboard, a mouse, and associated controllers, a hard drive or disk storage 106, various other subsystems 108, a network port 110 operable to connect to a network 160 to provide user access to a plurality of information handling system resources 158, and a system memory 112, all interconnected via one or more buses 114. The system memory 112 further comprises an operating system 116 and an automated usage profiling system 118.

As described in greater detail herein, the automated usage profiling system 118 further comprises a remote management system 120, and a fingerprinting system 124. The fingerprinting system 124 further comprises a survey module 126, an import module 128, a provisioning module 130, a scoring module 132, a weighting module 134, and a financial assessment module 136. Additionally, the automated usage profiling system 124 further comprises a rules service module 142, a rules engine 144, an online transaction processing (OLTP) module 150, a decision analytics module 152, and a document generation module 156.

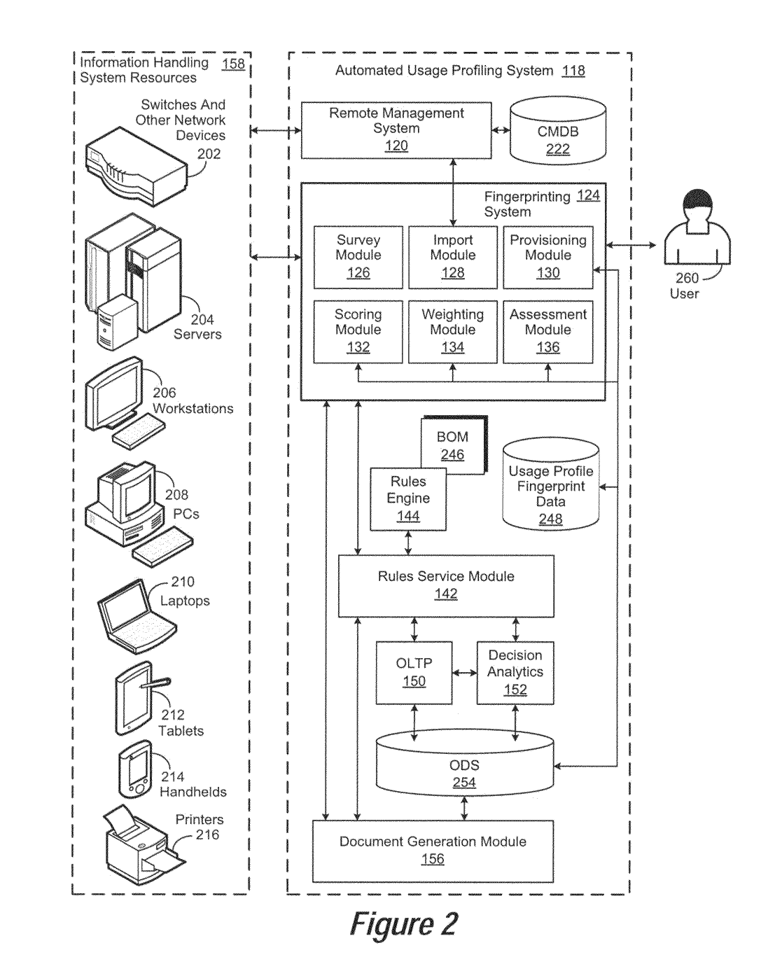

FIG. 2 is a simplified block diagram of an automated usage profiling system as implemented in accordance with an embodiment of the invention. In this embodiment, automated usage profiling operations are begun by selecting a user 260 for profiling. Survey information related to the selected user's 260 use of a plurality of information handling system (IHS) resources 158 is manually collected. As used herein, IHS resources 158 refer to any combination of devices, modules, systems, software, communication networks, processes, technologies, information, or resources used in the operation of the IHS resources 158. In various embodiments, IHS resources 158 may comprise switches and other network devices 202 used in a network, servers 204, workstations 206, personal computers 208, laptop computers 210, tablet computers 212, hand held devices 218 such as mobile telephones, scanners, and printers 216. The IHS resources 158 may also comprise resources for the operation of these resources such as the automated replenishment of in a printer or the exchanging of tape storage media in a tape drive.

As likewise used herein, survey information refers to information provided by a user 260 in response to a plurality of questions related to their past, current, or future use of a corresponding plurality of information handling system resources. In one embodiment, the survey information is collected as a result of the user 260 responding to a set of formalized questions. In another embodiment the user 260 is interviewed and the results of the interview are used to generate the survey information. Survey information not manually collected, but provided by the selected user 260 through an online interface to the automated usage profiling system 118, is collected. The collected survey information is then processed by a survey module 126 of the fingerprinting system 124 to generate survey information.

Individual IHS resources 158 associated with the user's 260 usage of the IHS resources are determined and associated configuration and operational information is collected. As used herein, operational information refers to information related to a user's 260 use of the individual IHS resources 158. In various embodiments, the configuration information and the operational information are automatically collected by a remote management system 120 as described in greater detail hereinbelow. In these and various other embodiments, the configuration information related to the IHS resources 158 is stored in a Configuration Management Database (CMDB) 222 familiar to those of skill in the art. In one embodiment, the automatically collected configuration information and operational information is provided by the remote management system 120 to an import module 128. Once provided, the collected configuration information and operational information is processed by the import module 128 to generate imported information. The survey information and the imported information are then stored in a repository of usage profile and usage fingerprint data 248.

Once stored, the survey information and the imported information are then processed by a scoring module 132 to generate a set of user usage scores as described in greater detail hereinbelow. The resulting user usage scores are then processed by the scoring module 132 to produce a user usage model, likewise described in greater detail hereinbelow. The resulting user usage model is then stored in the repository of usage profile and usage fingerprint data 248. The resulting user usage model is then processed by the scoring module 132 to generate a user usage fingerprint as described in greater detail hereinbelow. Once generated, the user usage fingerprint is stored in the repository of usage profile and usage fingerprint data 248.

Comparison operations are then performed between the user usage fingerprint and a plurality of reference usage profiles by a comparison and weighting module 134 as described in greater detail hereinbelow. As used herein, a reference usage profile refers to a defined combination of individual IHS resources 158 and operational information parameters related to a set of one or more users 260. The reference usage profile most closely matching the user usage fingerprint is then selected as described in greater detail hereinbelow. Once selected, a determination is made whether the user is currently associated with the selected reference usage profile. If so, then the user's association with the selected reference usage profile is not changed and IHS resources 158 and user operations are monitored by the remote management system 120 for events or changes.

If it is determined that the user 260 is not currently associated with the selected reference usage profile, then a usage weighting value is calculated. In one embodiment, the usage weighting value is proportionate to the difference between the user usage fingerprint and the selected reference usage profile. In various embodiments, the usage weighting value is calculated by the comparison and weighting module 134 as described in greater detail herein. A determination is then made whether the usage weighting value is within predetermined usage limits. If so, then sizing, return on investment (ROI) and total cost of ownership (TCO) calculations are performed by an assessment module 136, using a rules service module 142, a decision analytics module 152, the online transaction processing (OLTP) module 150, and information provided by an operational data store (ODS) 254 as described in greater detail hereinbelow.

In various embodiments, the ODS 254 comprises operational information related to the IHS resources 158 and the user's 260 use thereof. In one embodiment, the operational information stored in the ODS 254 is provided for use by the remote management system 120 for the monitoring of events and changes as described in greater detail herein. In various embodiments, the decision analytics module 152 processes the operational information provided by the ODS 254 to generate rules queries and to perform analysis operations related to the user's 260 use of the IHS resources 158. The OLTP module 150 likewise processes the operational information to generate rules queries and to perform rules processing transactions in various embodiments. In these and other embodiments, the rules service module receives requests for a rules query, submits the rules query to the rules engine 144, receives the results of the rules query from the rules engine 144, and provides the results of the rules query to the requestor. In various embodiments, the rules engine 144 comprises a plurality of rules referenced to a business object model (BOM) 246, wherein each of the plurality of rules defines at least one condition to be met and at least one action to be taken in response. In one embodiment, the BOM 246 comprises an extensible markup language (XML) schema. In various embodiments, the requestor of the rules query may be the fingerprinting system 124, the OLTP module 150, the decision analytics module 152, or the documentation generation module 156.

A determination is then made whether to associate the user 260 with the selected reference usage profile. As an example, the selected reference usage profile may have a usage weighting value that is closer to the user usage fingerprint than the reference usage profile currently associated with the user 260. If a decision is made to associate the user with the selected reference usage profile, then the provisioning module 130 is used to perform provisioning operations related to associating the user 260 with the selected reference usage profile. As an example, the provisioning operations may include moving the user's data to a different virtual machine or from a localized data store to a storage area network. It will be apparent to those of skill in the art that many such provisioning operations are possible and the foregoing are offered as examples and are not intended to limit the spirit, scope or intent of the invention.

Once the provisioning operations are completed, a sizing, ROI, and TCO report reflecting the decision is generated by the document generation module 156. However, if it is determined that the usage weighting value is not within predetermined usage limits, then the user usage fingerprint is processed by the assessment module 136 to perform sizing, ROI, and TCO calculations. In one embodiment, the assessment module 136, uses the rules service module 142, the decision analytics module 152, the OLTP 150 module, and information provided by the ODS 254 to perform the sizing, ROI, and TCO calculations. The results of the sizing, ROI and TCO calculations are then analyzed by the decision analytics module 152 to determine whether to generate a new reference usage profile from the user usage fingerprint. If so, a new reference usage profile is generated from the user usage fingerprint and then stored in the repository of usage profile and usage fingerprint data 248. A sizing, ROI, and TCO report reflecting the decision to generate the new reference usage profile from the user usage fingerprint is then generated by the document generation module 156.

A determination is then made whether sufficient IHS resources 158 are available to support the new reference usage profile. If so, then sizing, ROI and TCO analysis is performed to determine whether to associate the user 260 with the new reference usage profile. In one embodiment, the sizing, ROI and TCO analysis are performed by the assessment module 136, using the rules service module 142, the decision analytics module 152, the OLTP module 150, and information provided by the ODS 254. A determination is then made whether to associate the user 260 with the new reference usage profile. If not, of if it is determined that there are insufficient IHS resources 158 to support the new reference usage profile, then a sizing, ROI, and TCO report is generated by the document generation module 156 reflecting the decision to leave the user 260 associated with the current reference usage profile. However, if a decision is made to associate the user 260 with the new reference usage profile, then the association is performed. Once the association is performed, a sizing, ROI, and TCO report is then generated by the document generation module 156 reflecting the decision to associate the user 260 with the new reference usage profile.

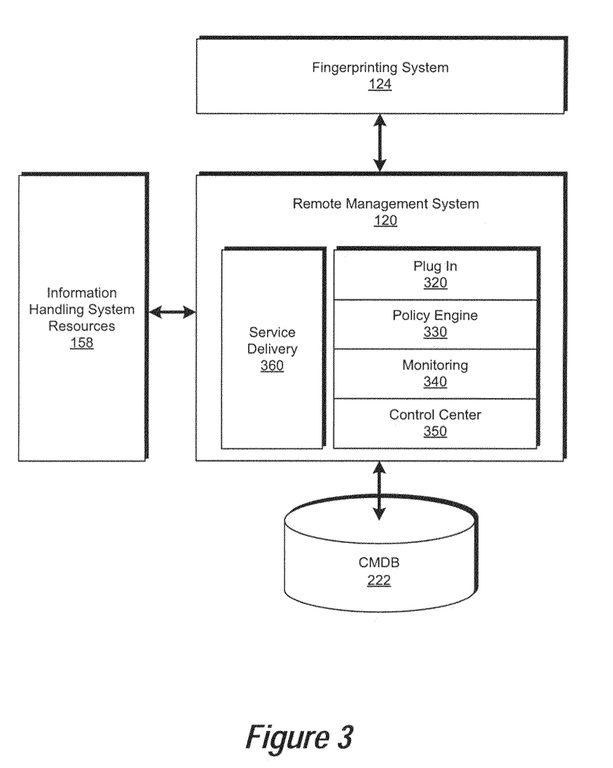

FIG. 3 is a simplified block diagram illustrating a remote management system 120 as implemented in accordance with an embodiment of the invention. The remote management system 120 comprises a plug-in module 320, a policy engine module 330, a monitoring module 340, a control center 350, and a service delivery module 360.

The plug-in module 320 allows various applications or functions to be selectively enabled and executed within the remote management system 120. The policy engine module 330 provides a policy administration function as well as intelligence regarding how to respond to events related to information handling system resources 158. The policy engine module 330 provides preferred action indications based upon service, configuration, and event information likewise related to information handling system resources 158. Likewise, the monitoring module 340 provides event level monitoring, license monitoring, and contract clause level monitoring of information handling system resources 158.

The control center 350 exposes a plurality of functions provided via the remote management system 120. More specifically, the control center 350 is delivers alerts based on events and data related to information handling system resources 158. The control center 350 also performs analytics functions which support reporting and analysis across device data, financial data, and application data gathered from the applications integrated within the remote management system 120. The control center 350 can also provide a user management function which allows administrators to maintain users in terms of roles, permissions, and a list of services a user is allowed to access. In addition, the control center 350 can provide a security function which supports security for sign-on, user access, and message encryption. Additionally, the control center 350 can provide a work flow function which provides work flow services to applications executing within the remote management system 120.

The service delivery platform 360 uses a combination of web services and command line application program interfaces (APIs) to support the integration of software applications and other functional components to deliver management services and provide functionality to the information handling system resources 158. The service delivery platform 360 can use services device agents resident on devices within an information technology (IT) environment comprising the information handling system resources 158. The service delivery platform 360 can also use a service appliance that communicates with the information handling system resources 158 within an IT environment.

Applications executing within the service delivery platform 360 may be delivered via an on-demand model as part of the remote management system 120 or may be provided via a third party service offering. The service delivery platform 360, through the use of the plug-in module 320, optionally and selectively supports service offerings such as asset management, virus protection, patch management, software distribution, and on-line backup. The service delivery platform 360, through the use of the policy engine module 330 and the monitoring module 340, also supports permissions management as well as service entitlement management functions, both of which can be provided via partners or independent software vendors who are making use of the remote management system 120. Permissions management allows user access to applications executing on the platform to be managed according to user specific roles and permissions associated with those roles. Service entitle management allows applications executing on the platform to deliver functionality based upon varying levels of service set by a customer or partner.

An IT environment can make use of service device agents deployed on individual information handling system resources 158 within the IT environment. The service device agents can provide a direct connection, such as through a network connection to the remote management system 120. The service device agents can execute either generic services or application specific services provided via the applications executing within the plug-in module 320. The service device agents and the service appliance provide an extensible mechanism for software download, inventory gathering, logging, diagnostics, and monitoring. The operations are accessible via a command line, API or Web Service (such as web services corresponding to standards set by the Web Services Interoperability Organization (WS-I)) on the agent or appliance and can be used by integration developers for integrating additional remote services functions. In various embodiments, the information collected via the service device agents or the service appliance is stored as configuration status information in a configuration management database (CMDB 222). In various embodiments, the information stored in CMDB 222 is provided by the remote management system 120 to the fingerprinting system 124, which then uses it to generate assessment information corresponding to the information handling system resources 158.

The service delivery platform 360 can include a plurality of application program interfaces (APIs). For example, the service delivery platform 360 can include user synchronization APIs which allow a service provider or third party to synchronize information with the remote management system 120. The service delivery platform 360 can also include data retrieval APIs which allow a service provider or third party to extract data from the service delivery platform 360.

Accordingly, the service delivery platform 360 can include customer-facing APIs which enable integration of existing data regarding users, software licenses, applications and other information that may be used by an application executing within the service delivery platform 360. The service delivery platform 360 can also include partner-facing APIs which enable partner service providers to link existing solutions, such as customer relationship management or service management, with the service delivery platform 360. As a result, these partner-facing APIs enable a partner using the service delivery platform 360 to deliver value added solutions on top of the service delivery platform, thereby facilitating multi-tier use of the service delivery platform 360. The service delivery platform 360 likewise enables the provision of remote services to customers at a service level agreement (SLA) level. Accordingly, a plurality of services may be provided to the customer where each of the services corresponds to a clause within a service level agreement.

In addition, the remote management system 120 enables and empowers a multi tier provision of remote services. With a multi tier provision of remote services, original equipment manufacturer (OEM) service providers or third party service providers can make use of the remote management system 120 to provide services to a customer where the actual location of the underlying remote management system 120 is transparent to the customer. Additionally, the remote management system 120 enables remote services to be provided using a software as a service (SaaS) business model, which in turn allows the provision of information technology as a service (ITaaS). Using this model, a customer might only be charged for the remote services that are actually used. In various embodiments, such charges are monitored by the monitoring module 340, with the actual supply chain for generated revenue provided by the remote management system 120.

The combination of the monitoring module 340 and the control center 350 facilitates reporting and billing of the services provided by the remote management system 120. Remote services provided via the SaaS model may also include other billing options such as subscription, pricing, flexible promotions and marketing, invoicing, financial management, payments, collections, partner relations, revenue analysis, and reporting. With zero or more subscriptions, balances, bills and payments per account, ITaaS pricing can include one-time, recurring, usage, or any event updatable payment method, flexibly based on tier, volume, time, zone attribute or customer. Bundling can include multi-service offerings, up-sell, cross-sell, discounts and promotions. Bundling can integrate a service offering registry with a service catalog management UI per tenant and tier to define a pricing scheme per event type, exclusion rules and dependencies, can create bundled offerings and manage price data or changes to any of these features. Balance management can include real-time threshold notification and balance updates. Service level balances may be provided with separate bills, credit limit monitoring, resource definition, management, and reservation with prepaid IT services. Multi-payment convergent accounts may be provided on a consolidated platform. A single partner or provider can view multiple balances, support sub-balances with validity dates. A service level can be balanced with separate bills and payment methods. Flexible promotions and rapid provider configuration enable marketing which can include quick response to a changing market and competitive purchase and upgrade incentives as well as select and group based promotions and volume and cross service discounts. It will be apparent to those of skill in the art that each of these typically has a corresponding configuration item residing in the CMDB 222. Furthermore, it will be equally apparent that each of the foregoing may be used in the generation of assessment information, whether for current or proposed information handling system resources 158, by the fingerprinting system 124.

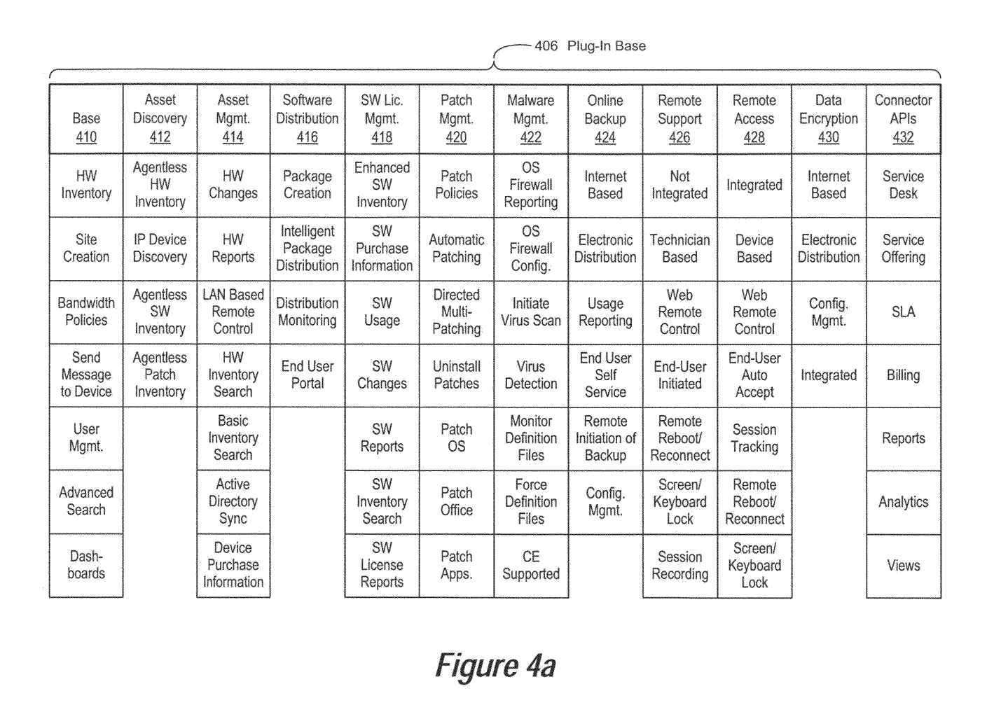

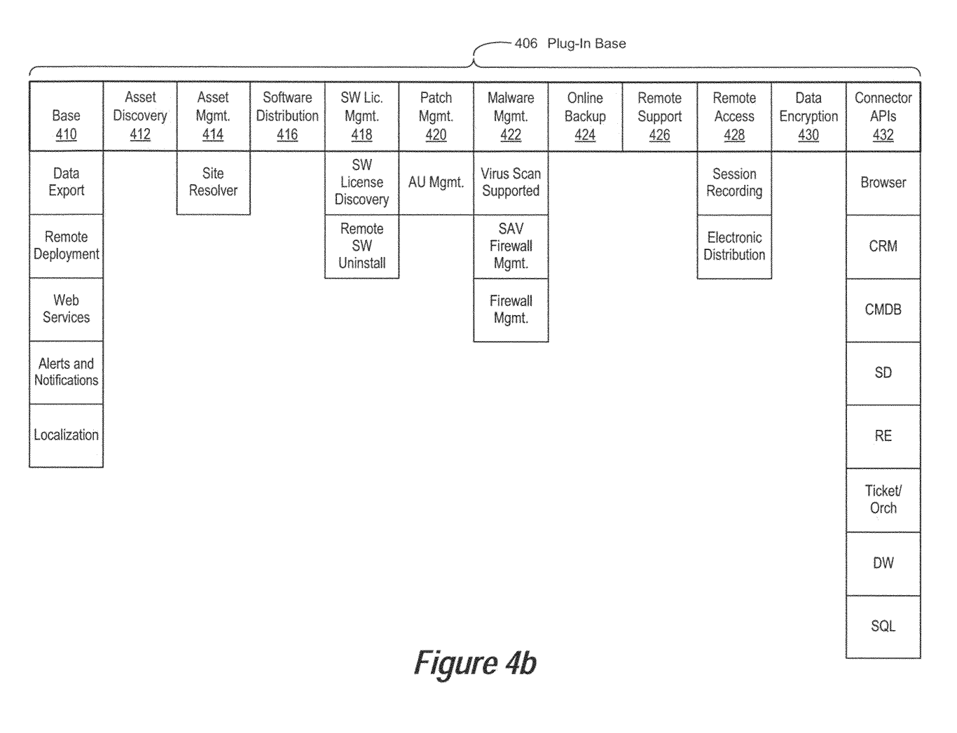

FIGS. 4a-b are a simplified block diagram of a plug-in module 320 as implemented with a service delivery module 360 in accordance with an embodiment of the invention. The plug-in module 320 includes a plug-in base portion 406 which can optionally include any combination of a plurality of plug-in functions. The plug-in base module 406 can control which of the plurality of plug-in functions to which a particular remote service customer might have access. Additionally, the plug-in base module 406 interacts with the monitoring module 340 to enable a remoter services provider to track and bill for each of the enabled plug-in functions.

In certain embodiments, the plug-in functions can include one or more of a base function 410, an asset discovery function 412, an asset management function 414, a software distribution function 416, a software license management function 418, a patch management function 420, an anti-malware management function 422, an online backup function 424, a remote support function 426, a remote access function 428, a data encryption function 430, and a connector API function 432. By providing these functions within the plug-in module 320, it is possible to allow a service provider to easily add or remove functionality to the remote services that are being provided to a particular customer via the service delivery module 360.

Each of the plurality of plug-in functions can include one or more plug-in applications or application-like service independent building blocks (SIBB). For example, the base function can include a hardware inventory application, a site creation application, a bandwidth policy application, a send message to device application, a user management application, an advanced search application, a dashboard application, a data export application, a remote deployment application, a web services application, an alerts and notifications application and a localization application. The various applications may be different brands of applications, different applications within a brand or different versions within the application. The SIBB plug-in functions can include sub-parts of applications, which may include separate service offerings as well as additional extensible markup language (XML) document type definitions (DTDs) or schema and their integrations.

By providing these functions within the plug-in module 320 it is possible for a service provider to easily change a type of application for each of the functions. As an example, a customer might desire changing from a first brand or version of anti virus software application to another brand or version of anti virus software application, or more than one type of application (e.g., for multiple customer sites, for legacy applications or for acquisitions within the customer IT environment). As will likewise be appreciated by those of skill in the art, each of these will generally have a corresponding configuration item stored in the CMDB 222. As such, the fingerprinting system 124 is operable in various embodiments to generate assessment information for each such application, and by extension, assessment information for a predetermined target group of corresponding information handling system resources 158.

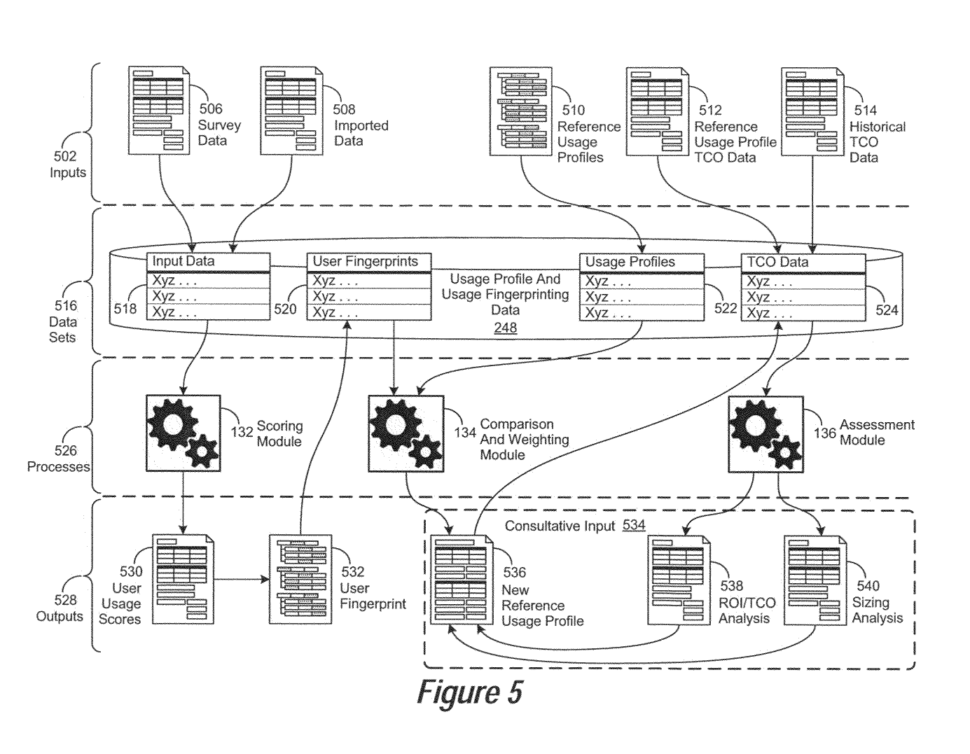

FIG. 5 is a simplified process flow diagram of the operation of an automated usage profiling system as implemented in accordance with an embodiment of the invention to generate reference usage profile recommendations. In this embodiment, automated usage profiling inputs 502 are converted into data sets 516, which are in turn used by processes 526 to generate outputs 528. In various embodiments, processes 526 are contributory to consultative input 534. In this embodiment, usage profiling inputs 502 comprise survey data 506, imported data 508, reference usage profiles 510, reference usage profile total cost of ownership (TCO) data 512, and historical TCO data 514. The data sets 516 are stored in a repository of usage profile and usage fingerprinting data 248, further comprising input data sets 518, user usage fingerprint data sets 520, reference usage profile data sets 522, and TCO data sets 524. Processes 526 comprise reference usage profile and user usage profile processes performed by a scoring module 132, a comparison and weighting module 134, and an assessment module 136. Outputs 528 comprise user scores 530, which are used to generate user usage models, which are in turn used to generate a user usage fingerprint 532 as described in greater detail herein. Outputs 528 further comprise consultative input 534, which in turn further comprises reference usage profile recommendations 536, return on investment (ROI) and TCO reports 538, and sizing reports 540. In various embodiments, reference usage profiles 510 are converted into reference usage profile data sets 522 and stored in the repository of usage profile and usage fingerprinting data 248. In these and other embodiments, reference usage profile TCO data 512 and historical TCO data 514 are respectively converted into TCO data sets 524 and likewise stored in the repository of usage profile and usage fingerprinting data 248.

In this embodiment, automated usage profiling operations are begun by selecting a user for usage profiling. Information related to the selected user's use of a plurality of information handling system (IHS) resources is collected manually or online. In one embodiment, the usage information is generated as a result of the user responding to a set of formalized survey questions. In another embodiment the user is interviewed and the results of the interview are used to generate the usage information. The collected usage information is then processed by a survey module of the fingerprinting system to generate survey data 506.

Individual IHS resources associated with the user's use of the IHS resources are determined and associated configuration and operational information is collected. As used herein, operational information refers to information related to a user's use of the individual IHS resources. In various embodiments, the configuration information and the operational information are automatically collected by a remote management system as described in greater detail herein. In one embodiment, the automatically collected configuration information and operational information is provided by the remote management system to an import module. Once provided, the collected configuration information and operational information is processed by the import module to generate imported data 508. The survey data 506 and the imported data 508 are then converted into data sets and stored as input data sets 518 in the repository of usage profile and usage fingerprint data 248.

Once stored, the survey information and the imported information are then processed by a scoring module 132 to generate a set of user usage scores 530 as described in greater detail hereinbelow. The resulting user usage scores 530 are then processed by the scoring module 132 to produce a user usage model, likewise described in greater detail hereinbelow. The resulting user usage model is then processed by the scoring module 132 to generate a user usage fingerprint 532 as described in greater detail herein. Once generated, the user usage fingerprint is stored as a user usage fingerprint data set 520 in the repository of usage profile and usage fingerprint data 248.

Comparison operations are then performed between the user usage fingerprint data set 520 corresponding to the user usage fingerprint 532 and a plurality of reference usage profile data sets 522 by a comparison and weighting module 134 as described in greater detail herein. As used herein, a reference usage profile 522 refers to a defined combination of individual IHS resources and operational information parameters related to a set of one or more users. The reference usage profile data set 522 most closely matching the user usage fingerprint data set 520 corresponding to the user usage fingerprint 532 is then selected as described in greater detail herein. Once selected, a determination is made whether the user is currently associated with the selected reference usage profile data set 522. If so, then the user's association with the selected reference usage profile data set 522 is not changed.

If a determination is made that the user is not currently associated with the selected reference usage profile data set 522, then a usage weighting value is calculated by the comparison and weighting module 134. In one embodiment, the usage weighting value is proportionate to the difference between the user usage fingerprint data set 520 and the selected reference usage profile data set 522. A determination is then made whether the usage weighting value is within predetermined usage limits. If so, then a determination is made whether to associate the user with the selected reference usage profile data set 522. However, if it is determined that the usage weighting value is not within predetermined usage limits, then a sizing analysis 540 and a ROI/TCO analysis 538 are performed by an assessment module 136. The results of the sizing analysis 540 and the ROI/TCO analysis 538 are then used to determine whether to generate a new reference usage profile 536 from the user usage fingerprint data set 520 associated with the user usage fingerprint 532. If so, a new reference usage profile 536 is generated from the user usage fingerprint data set 520 and then stored as a usage profile data set 522 in the repository of usage profile and usage fingerprint data 248.

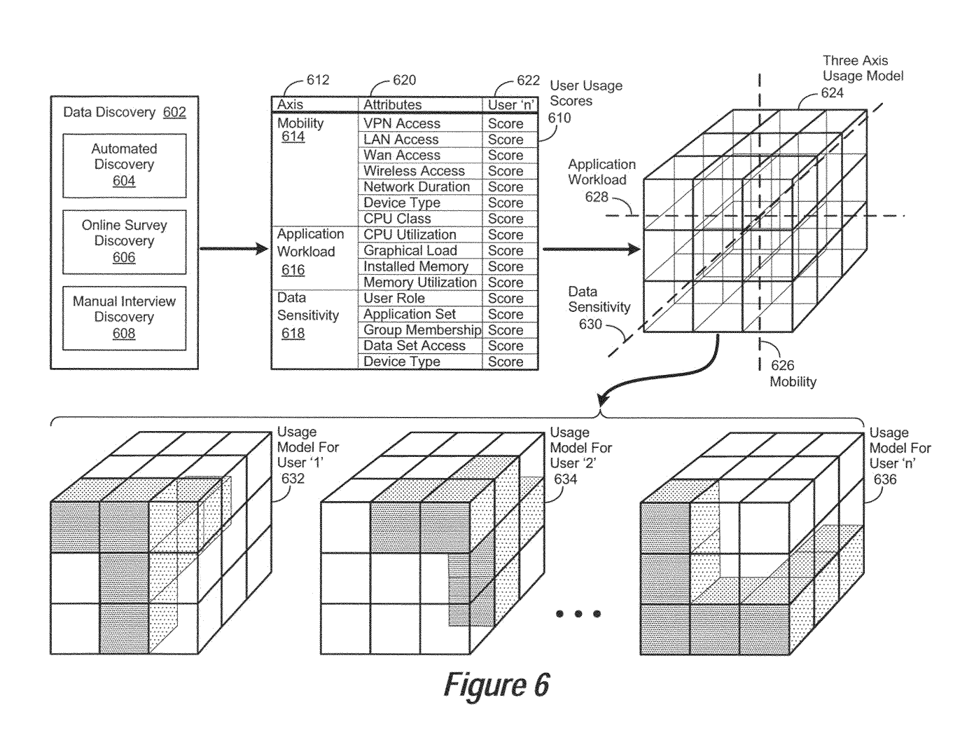

FIG. 6 is a simplified block diagram of the automated generation of a user usage score as implemented in accordance with an embodiment of the invention to generate a corresponding user usage model. In various embodiments, information related to a user's use of a plurality of information handling system (IHS) resources is collected via data discovery processes 602. In these and other embodiments, data discovery processes 602 comprise automated discovery 604, online survey discovery 606, and manual interview discovery 608.

In one embodiment, the online survey discovery 606 process generates the usage information as a result of the user responding online to a set of formalized survey questions. In another embodiment, the manual interview discovery 608 process generates the usage information from the results of a user interview. In yet another embodiment, the automated discovery 604 process automatically collects configuration information and operational information related to the user's use of the IHS resources. In various embodiments, the configuration information and the operational information are automatically collected by a remote management system and provided to an import module of a fingerprinting system as described in greater detail herein.

Once the usage information is generated by the data discovery process 602, it is used by a scoring module to generate a set of user usage scores 610. In this embodiment, the set of user usage scores 610 comprise an axis association 612, attributes 620, and a score for user ‘n’ 622. The axis association 612 is used by the scoring module to produce a user-specific (e.g., user ‘n’) instantiation of a three axis usage model 624. In one embodiment, the user usage model comprises a three dimensional cartesian model, further comprising three axis, each with a corresponding indicia. As shown in FIG. 6, the axis association 612 comprises ‘Mobility’ 614, ‘Application Workload’ 616, and ‘Data Sensitivity’ 618. Each of these respectively correspond to the ‘Mobility’ 626, ‘Application Workload’ 628, and ‘Data Sensitivity’ 630 axis of the three axis usage model 624.

In various embodiments, the scoring module processes user usage scores 610 for each user to generate user-specific usage models for user ‘1’ 632, user ‘2’ 634, and user ‘n’ 636. For example, visual examination of the usage model for user ‘a’ 632 indicates that the user is both mobile and stationary, with a light application workload that comprises data that can range from very sensitive to not very sensitive. In contrast, the usage model for user ‘b’ 634 indicates that the user is also both mobile and stationary, with a moderate to heavy application workload that comprises data that is moderately sensitive to not very sensitive. As another example, the usage model for user ‘n’ 636 indicates that the user is both mobile and stationary, with a low to high application workload that comprises data less sensitive to very sensitive.

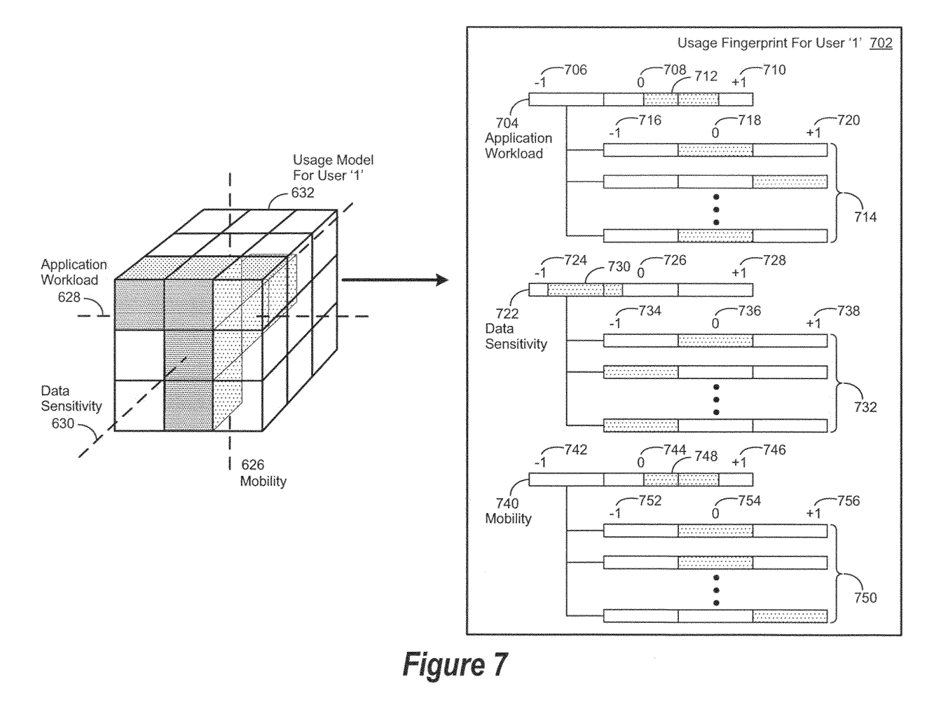

FIG. 7 is a simplified block diagram of a user usage model as implemented in accordance with an embodiment of the invention to generate a corresponding user usage fingerprint. In this embodiment, the usage model for user ‘1’ 632 comprises a ‘Mobility’ 626, ‘Application Workload’ 628, and ‘Data Sensitivity’ 630 axis. In various embodiments a scoring module of a fingerprinting system processes the usage model for user ‘1’ 632 to produce a corresponding usage fingerprint for user ‘1’ 702. The resulting usage fingerprint for user ‘1’ 702 comprises data set summary values ‘Mobility’ 740, ‘Application Workload’ 704, and ‘Data Sensitivity’ 722, visually displayed in relation to indicia on a bar graph. As shown in FIG. 7, the ‘Application Workload’ 704 summary value 712 is shown in relation to a low ‘−1’ 706, moderate ‘0’ 708, and high ‘+1’ 710 indicia value. The summary value 712 is calculated from a plurality of sub-values 714, each corresponding to a different application workload usage attribute and likewise having a low ‘−1’ 716, moderate ‘0’ 718, and high ‘+1’ 720 indicia value. As likewise shown in FIG. 7, the ‘Data Sensitivity’ 722 summary value 730 is shown in relation to a low ‘−1’ 724, moderate ‘0’ 726, and high ‘+1’ 728 indicia value. The summary value 730 is calculated from a plurality of sub-values 732, each corresponding to a different data sensitivity usage attribute and likewise having a low ‘−1’ 734, moderate ‘0’ 738, and high ‘+1’ 738 indicia value. Likewise, the ‘Mobility’ 740 summary value 748 is shown in relation to a low ‘−1’ 742, moderate ‘0’ 744, and high ‘+1’ 746 indicia value. The summary value 748 is calculated from a plurality of sub-values 750, each corresponding to a different mobility usage attribute and likewise having a low ‘−1’ 752, moderate ‘0’ 754, and high ‘+1’ 756 indicia value.

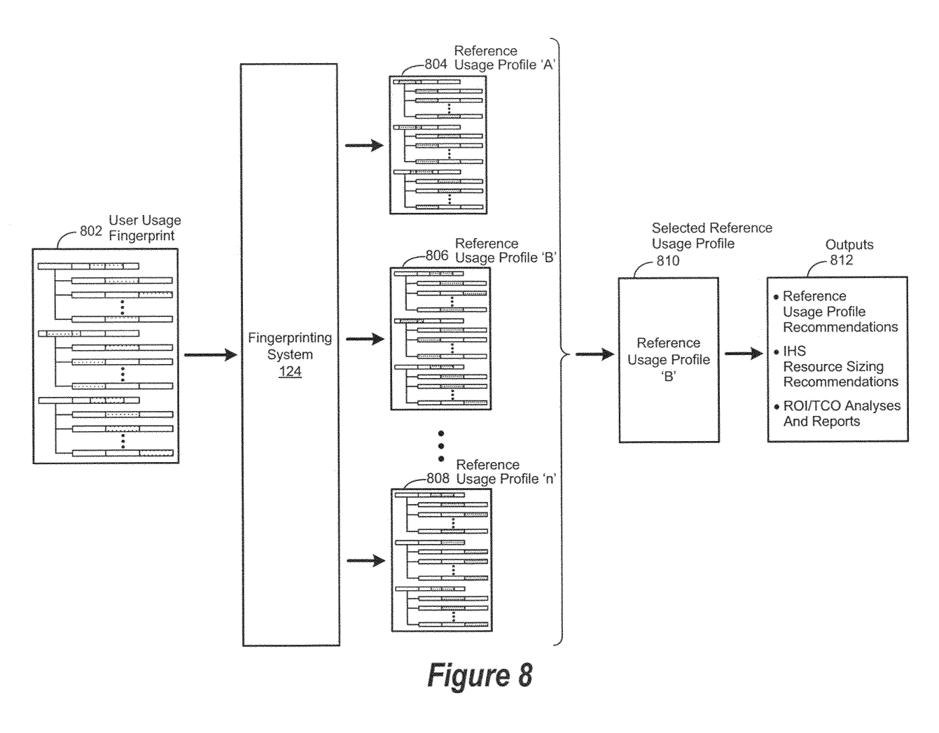

FIG. 8 is a simplified block diagram of a fingerprinting system as implemented in accordance with an embodiment of the invention to determine a reference usage profile most closely matching an individual user usage fingerprint. In various embodiments, comparison operations are performed between a user usage fingerprint 802 and a plurality of reference usage profiles ‘A’ 804, ‘B’ 806 through ‘n’ 808 by a fingerprinting system 124 as described in greater detail herein. In this embodiment, the result of the comparison operations determines that reference usage model ‘B’ 806 most closely matches the user usage fingerprint 802. Accordingly, usage model ‘B’ 806 is used as the selected reference usage profile 810 to be associated with the user corresponding to the user usage fingerprint 802. In various embodiments, the selected reference usage profile 810 is then used to generate outputs 812, such as reference usage profile recommendations and IHS resource sizing recommendations, as well as TCO and ROI analyses and reports.

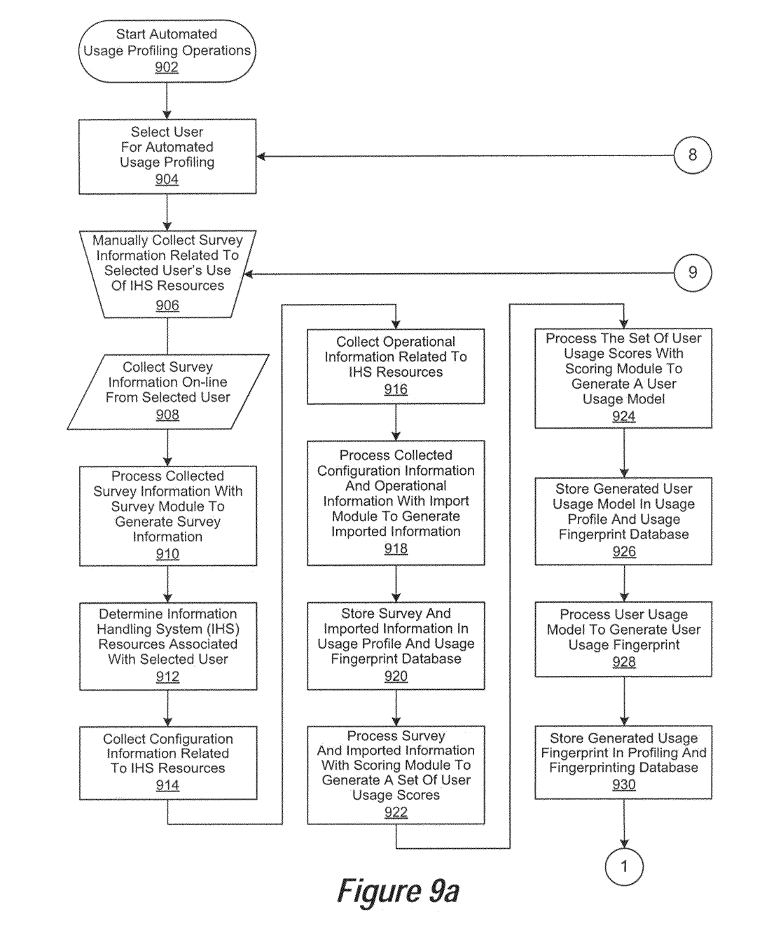

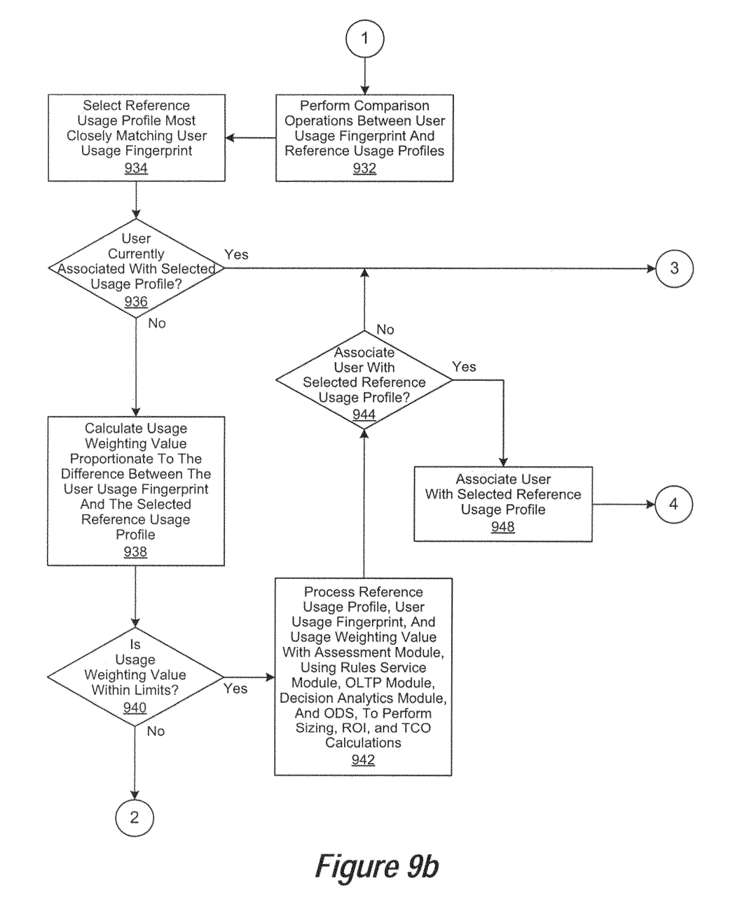

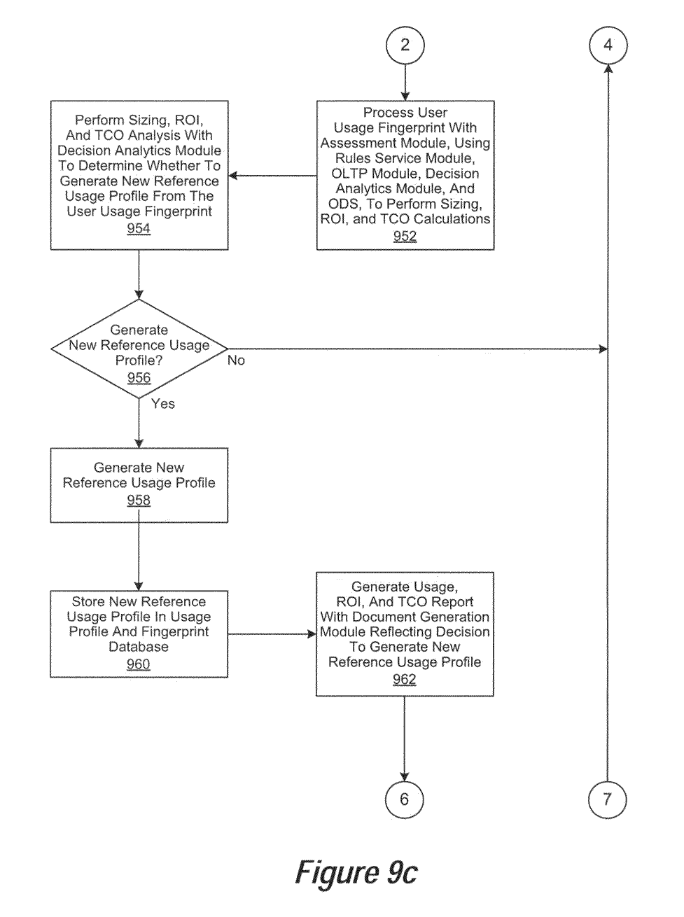

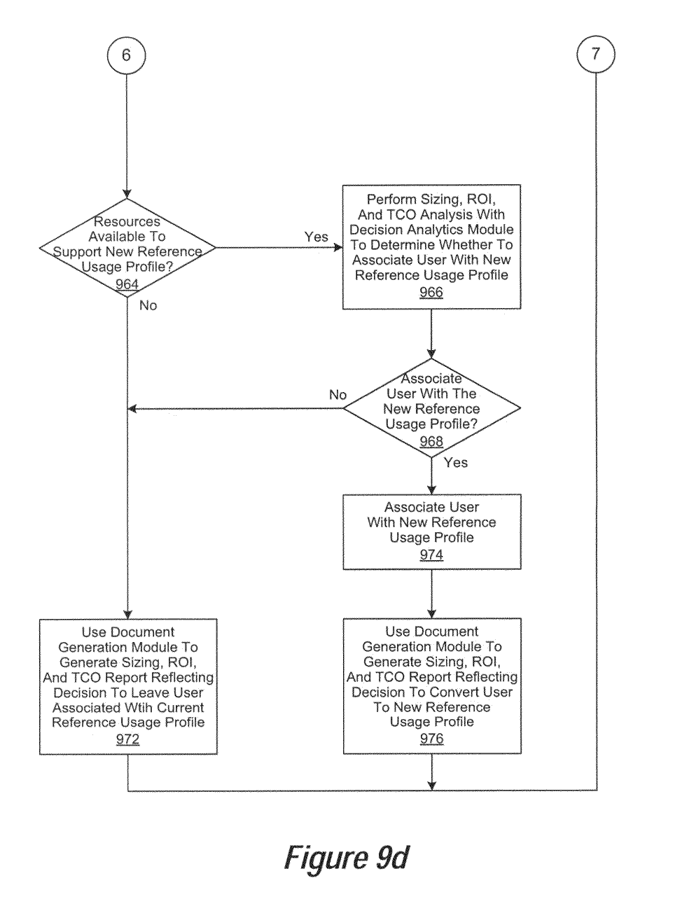

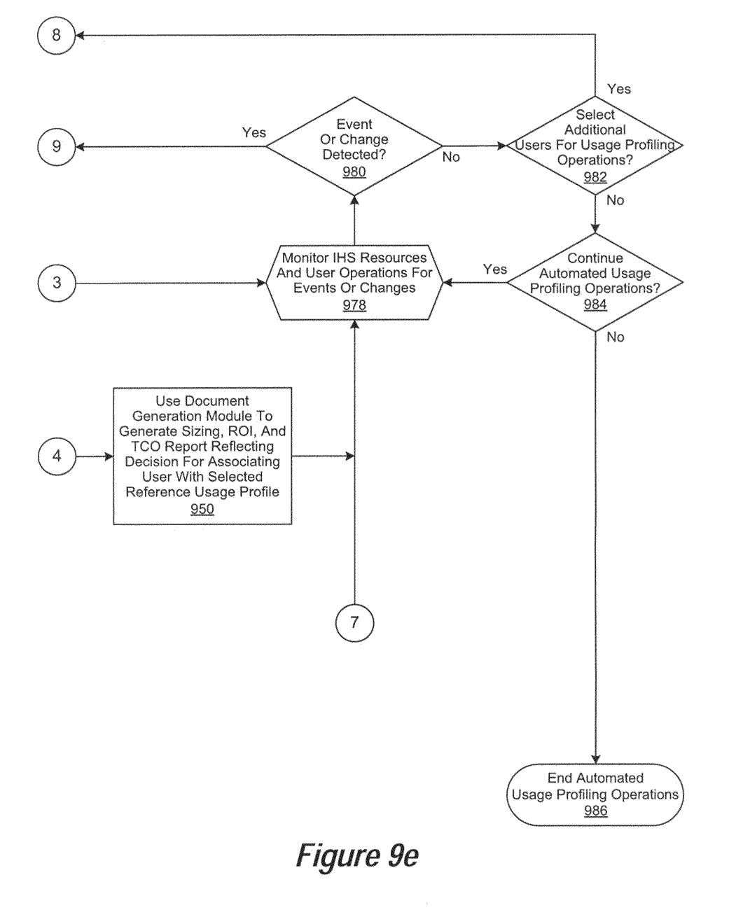

FIGS. 9a-d are a flow chart of the operation of an automated usage profiling system as implemented in accordance with an embodiment of the invention to generate user usage fingerprints. In this embodiment, automated usage profiling operations are begun in step 902, followed by the selection of a user for profiling in step 904. In step 906 survey information related to the selected user's use of a plurality of information handling system (IHS) resources is manually collected. As used herein, IHS resources refer to any combination of devices, modules, systems, software, communication networks, processes, technologies, information, or resources used in the operation of the IHS resources. In various embodiments, IHS resources may comprise switches and other network devices used in a network, servers, workstations, personal computers, laptop computers, tablet computers, hand held devices such as mobile telephones, scanners, and printers. The IHS resources may also comprise resources for the operation of these resources such as the automated replenishment of in a printer or the exchanging of tape storage media in a tape drive.

As likewise used herein, survey information refers to information provided by a user in response to a plurality of questions related to their past, current, or future use of a corresponding plurality of information handling system resources. In one embodiment, the survey information is collected as a result of the user responding to a set of formalized questions. In another embodiment the user is interviewed and the results of the interview are used to generate the survey information. In step 908, survey information not manually collected, but provided by the selected user through an online interface to the automated usage profiling system, is collected. The collected survey information is then processed by a survey module of the fingerprinting system in step 910 to generate survey information.

Individual IHS resources associated with the users usage of the plurality of IHS resources are then determined in step 912. Once determined, associated configuration information is collected in step 914 and associated operational information is collected in step 916. As used herein, operational information refers to information related to a user's use of the individual IHS resources. In various embodiments, the configuration information and the operational information are automatically collected by a remote management system described in greater detail herein. In these and various other embodiments, the configuration information related to the plurality of IHS resources is stored in a Configuration Management Database (CMDB) familiar to those of skill in the art. In one embodiment, the automatically collected configuration information and operational information is provided by the remote management system to an import module. Once provided, the collected configuration information and operational information is processed by the import module to generate imported information in step 918. The survey information and the imported information are then stored in a repository of usage profile and usage fingerprint information in step 920.

Once stored, the survey information and the imported information are then processed in step 922 by a scoring module to generate a set of user usage scores as described in greater detail herein. The resulting user usage scores are then processed in step 924 by the scoring module to produce a user usage model, as likewise described in greater detail herein. The resulting user usage model is then stored in the repository of usage profile and usage fingerprint information in step 926. In one embodiment, the user usage model comprises a three dimensional cartesian model, further comprising three axis, each with a corresponding indicia. In one embodiment, the three axis correspond to application workload, data sensitivity, and mobility aspects of the user's usage of the IHS resources. In another embodiment, the corresponding indicia of each axis provide metrics associated with the user's usage of the IHS resources. The resulting user usage model is then processed in step 928 by the scoring module to generate a user usage fingerprint as described in greater detail herein. Once generated, the user usage fingerprint is stored in the repository of usage profile and usage fingerprint information in step 930.

Comparison operations are then performed in step 932 between the user usage fingerprint and a plurality of reference usage profiles by a comparison and weighting module as described in greater detail herein. As used herein, a reference usage profile refers to a defined combination of individual IHS resources and operational information parameters related to a set of one or more users. In one embodiment, the reference usage profile is generated by duplicating an exemplary user usage fingerprint. In another embodiment, the reference usage profile is generated by normalizing and rationalizing a plurality of user usage fingerprints. In yet another embodiment, the reference usage profile is generated as a proposed combination of individual IHS resources and operational information parameters for implementation by one or more users. It will be apparent to skilled practitioners of the art that many such embodiments are possible and the foregoing are offered only as examples and are not intended to limit the spirit, scope or intent of the invention.

In step 934, the reference usage profile most closely matching the user usage fingerprint is selected as described in greater detail herein. Once selected, a determination is made in step 936 whether the user is currently associated with the selected reference usage profile. If so, then the user's association with the selected reference usage profile is not changed and IHS resources and user operations are monitored in step 978 for events or changes. A determination is then made in step 980 whether an event or a change has been detected. If so, then the process continues, proceeding with step 906. Otherwise, a determination is made in step 982 whether additional users are to be selected for automated usage profiling operations. If so, then the process continues, proceeding with the selection of a user for automated usage profiling in step 904. Otherwise, a determination is made in step 984 whether to continue automated profiling operations. If so, then the process continues, proceeding with step 978. Otherwise, automated usage profiling operations are ended in step 986.

However, if it is determined in step 936 that the user is not currently associated with the selected reference usage profile, then a usage weighting value is calculated in step 938. In one embodiment, the usage weighting value is proportionate to the difference between the user usage fingerprint and the selected reference usage profile. In various embodiments, the usage weighting value is calculated by a comparison and weighting module as described in greater detail herein. Those of skill in the art will recognize that other usage weighting values and methods of calculation are possible for use and implementation in other embodiments.

A determination is then made in step 940 whether the usage weighting value is within predetermined usage limits. As an example, a reference usage profile and a user usage fingerprint may have a mobility metric. In this example, a value of −2 would equate to usage of an IHS resource that is primarily stationary, a value of 0 equates to usage that is both stationary and mobile, and a value of +2 equates to usage that is primarily mobile. If the reference usage profile had a mobility metric value of 0 and the user usage fingerprint had a mobility metric value of +2, then the usage weighting value would have a value of 0.5. The usage weighting value of 0.5 would indicate that the reference usage profile would only represent 50% of the mobility usage metric for the user usage fingerprint. However, if the reference usage profile had a metric value of +1, then the usage weighting value would have a value of 0.75, equating to 75% of the mobility usage metric for the user usage fingerprint. In one embodiment, the usage weighting value is calculated from a plurality of such metrics.

If it is determined in step 940 that the usage weighting value is within predetermined usage limits, then sizing, return on investment (ROI) and total cost of ownership (TCO) calculations are performed in step 942. In one embodiment, the sizing, ROI and TCO calculations are performed by an assessment module, using a rules service module, a decision analytics module, and information provided by an operational data store (ODS) as described in greater detail herein. A determination is then made in step 944 whether to associate the user with the selected reference usage profile. As an example, the selected reference usage profile may have a usage weighting value that is closer to the user usage fingerprint than the reference usage profile currently associated with the user. As another example, the selected reference usage profile may have a higher ROI or lower TCO than the user usage fingerprint than the reference usage profile currently associated with the user.

If it is determined in step 944 to not associate the user with the selected reference usage profile, then the process continues, proceeding with step 978. Otherwise, the user is associated with the selected reference usage profile in step 948. A sizing, ROI, and TCO report reflecting the decision to associate the user with the selected reference usage profile is then generated in step 850. In one embodiment, the sizing, ROI, and TCO report is generated by a document generation module as described in greater detail herein. The process is then continued, proceeding with step 978.

However, if it is determined in step 940 that the usage weighting value is not within predetermined usage limits, then the user usage fingerprint is processed in step 952 to perform sizing, ROI, and TCO calculations. In one embodiment, the sizing, ROI and TCO calculations are performed by an assessment module, using a rules service module, a decision analytics module, and information provided by an operational data store (ODS) as described in greater detail herein. The results of the sizing, ROI and TCO calculations are then analyzed in step 954, using a decision analytics module to determine whether to generate a new reference usage profile from the user usage fingerprint. As an example, the usage weighting value of a user usage fingerprint may exceed the predetermined usage limits of the closest-matching reference usage profile. However, the results of the sizing, ROI and TCO calculations may indicate that the user usage fingerprint may represent a higher ROI and lower TCO, thereby justifying its use as a new reference usage profile.

A determination is then made in step 956 whether to generate a new reference usage profile from the user usage fingerprint. If not, then the process continues, proceeding with step 978. Otherwise, a new reference usage profile is generated from the user usage fingerprint in step 958. The newly generated reference usage profile is then stored in a repository of usage profile and usage fingerprint information in step 960. A sizing, ROI, and TCO report reflecting the decision to generate the new reference usage profile from the user usage fingerprint is then generated in step 850. In one embodiment, the sizing, ROI, and TCO report is generated by a document generation module as described in greater detail herein.

A determination is then made in step 964 whether sufficient IHS resources are available to support the new reference usage profile. If so, then sizing, ROI and TCO analysis is performed in step 966 to determine whether to associate the user with the new reference usage profile. In one embodiment, the sizing, ROI and TCO analysis are performed by an assessment module, using a rules service module, a decision analytics module, and information provided by an operational data store (ODS) as described in greater detail herein. A determination is then made in step 968 whether to associate the user with the new reference usage profile. If not, of if it is determined in step 964 that there are insufficient IHS resources to support the new reference usage profile, then a sizing, ROI, and TCO report is generated in step 972 reflecting the decision to leave the user associated with the current reference usage profile. In one embodiment, the sizing, ROI, and TCO report is generated by a document generation module as described in greater detail herein. The process is then continued, proceeding with step 978. However, if it is determined in step 968 to associate the user with the new reference usage profile, then the association is performed in step 974. A sizing, ROI, and TCO report is then generated in step 976 reflecting the decision to associate the user associated with the new reference usage profile. In one embodiment, the sizing, ROI, and TCO report is generated by a document generation module as described in greater detail herein. The process is then continued, proceeding with step 978.

The present invention is well adapted to attain the advantages mentioned as well as others inherent therein. While the present invention has been depicted, described, and is defined by reference to particular embodiments of the invention, such references do not imply a limitation on the invention, and no such limitation is to be inferred. The invention is capable of considerable modification, alteration, and equivalents in form and function, as will occur to those ordinarily skilled in the pertinent arts. The depicted and described embodiments are examples only, and are not exhaustive of the scope of the invention.

For example, the above-discussed embodiments include software modules that perform certain tasks. The software modules discussed herein may include script, batch, or other executable files. The software modules may be stored on a machine-readable or computer-readable storage medium such as a disk drive. Storage devices used for storing software modules in accordance with an embodiment of the invention may be magnetic floppy disks, hard disks, or optical discs such as CD-ROMs or CD-Rs, for example. A storage device used for storing firmware or hardware modules in accordance with an embodiment of the invention may also include a semiconductor-based memory, which may be permanently, removably or remotely coupled to a microprocessor/memory system. Thus, the modules may be stored within a computer system memory to configure the computer system to perform the functions of the module. Other new and various types of computer-readable storage media may be used to store the modules discussed herein. Additionally, those skilled in the art will recognize that the separation of functionality into modules is for illustrative purposes. Alternative embodiments may merge the functionality of multiple modules into a single module or may impose an alternate decomposition of functionality of modules. For example, a software module for calling sub-modules may be decomposed so that each sub-module performs its function and passes control directly to another sub-module.

Consequently, the invention is intended to be limited only by the spirit and scope of the appended claims, giving full cognizance to equivalents in all respects.

What is claimed is:

1. A system for the automated provision of usage profiles, comprising:
a fingerprinting system operable to generate a user usage fingerprint using information related to a plurality of information handling system resources and a user's use thereof.

2. The system of claim 1, wherein the fingerprinting system further comprises:
a survey module operable to process manually provided information related to the plurality of information handling system resources the user's use thereof to generate survey information;
an import module operable to process automatically collected information related to the configuration status of the plurality of information handling system resources and the user's use thereof to generate imported information; and
a provisioning module operable to perform provisioning operations related to the plurality of information handling system resources and the user's use thereof.

3. The system of claim 1, wherein the fingerprinting system further comprises:
a scoring module operable to:
process the survey information and the imported information to generate a set of user usage scores;
process the set of user usage scores to generate a user usage model; and
process the user usage model to generate a user usage fingerprint.

4. The system of claim 1, wherein the fingerprinting system further comprises:
a comparison and weighting module operable to:
perform comparison operations between the user usage fingerprint and a plurality of reference usage profiles;
select the reference usage profile from the plurality of reference usage profiles that most closely matches the user usage fingerprint associated with the user; and
calculate a usage weighting value proportionate to the difference between the user usage fingerprint and the closest matching reference usage profile.

5. The system of claim 1, wherein the fingerprinting system further comprises:
an assessment module operable to process the selected reference usage profile, the user usage fingerprint, and the usage weighting value to perform sizing, return on investment (ROI), and total cost of ownership (TCO) calculations.

6. The system of claim 1, further comprising:
an operational data store (ODS) comprising operational information related to the plurality of information handling system resources and the user's use thereof;
an online transaction processing (OLTP) module operable to process the operational information to generate rules queries and to perform rules processing transactions; and
a decision analytics module operable to process the operational information to generate rules queries and to perform analysis operations.

7. The system of claim 1, further comprising:
a repository of usage profile information and user usage fingerprint information;
a rules engine comprising a plurality of rules referenced to a business object model, wherein each of the plurality of rules defines at least one condition to be met and at least one action to be taken in response and the business object module comprises an extensible markup language (XML) schema;
a rules service module operable to receive a request for a rules query, submit the rules query to the rules engine, receive the results of the rules query from the rules engine, and provide the results of the rules query to the requestor; and
a document generation module operable to provide the usage profile information and the user usage fingerprint information in a predetermined format.

8. The system of claim 7, wherein the requestor of the rules query comprises:
the fingerprinting system,
the OLTP module,
the decision analytics module, or
the document generation module.

9. The system of claim 1, further comprising:
a remote management system operable to:
automatically collect information related to the configuration status of the plurality of information handling resources and the user's use thereof; and
provide the automatically collected information to the import module of the usage profile fingerprinting system.

10. The system of claim 9, wherein the configuration status information related to the plurality of information handling resources is stored in a configuration management database (CMDB).

11. A method for the automated provision of usage profiles, comprising:
using a fingerprinting system to generate a user usage fingerprint using information related to a plurality of information handling system resources and a user's use thereof.

12. The method of claim 11, wherein the fingerprinting system further comprises:
using a survey module to process manually provided information related to the plurality of information handling system resources the user's use thereof to generate survey information;
using an import module to process automatically collected information related to the configuration status of the plurality of information handling system resources and the user's use thereof to generate imported information; and
using a provisioning module to perform provisioning operations related to the plurality of information handling system resources and the user's use thereof.

13. The method of claim 11, wherein the fingerprinting system further comprises:
using a scoring module to:
process the survey information and the imported information to generate a set of user usage scores;
process the set of user usage scores to generate a user usage model; and
process the user usage model to generate a user usage fingerprint.

14. The method of claim 11, wherein the fingerprinting system further comprises:
using a comparison and weighting module to:
perform comparison operations between the user usage fingerprint and a plurality of reference usage profiles;
select the reference usage profile from the plurality of reference usage profiles that most closely matches the user usage fingerprint associated with the user; and
calculate a usage weighting value proportionate to the difference between the user usage fingerprint and the closest matching reference usage profile.

15. The method of claim 11, wherein the fingerprinting system further comprises:
using an assessment module to process the selected reference usage profile, the user usage fingerprint, and the usage weighting value to perform sizing, return on investment (ROI), and total cost of ownership (TCO) calculations.

16. The method of claim 11, further comprising:
using an operational data store (ODS) comprising operational information related to the plurality of information handling system resources and the user's use thereof;
using an online transaction processing (OLTP) module to process the operational information to generate rules queries and to perform rules processing transactions; and
using a decision analytics module to process the operational information to generate rules queries and to perform analysis operations.

17. The method of claim 11, further comprising:
using a repository of usage profile information and user usage fingerprint information;
using a rules engine comprising a plurality of rules referenced to a business object model, wherein each of the plurality of rules defines at least one condition to be met and at least one action to be taken in response and the business object module comprises an extensible markup language (XML) schema;
using a rules service module to receive a request for a rules query, submit the rules query to the rules engine, receive the results of the rules query from the rules engine, and provide the results of the rules query to the requestor; and
using a document generation module to provide the usage profile information and the user usage fingerprint information in a predetermined format.

18. The method of claim 17, wherein the requestor of the rules query comprises:
the fingerprinting system,
the OLTP module,
the decision analytics module, or
the document generation module.

19. The method of claim 11, further comprising:
using a remote management system to:
automatically collect information related to the configuration status of the plurality of information handling resources and the user's use thereof; and
provide the automatically collected information to the import module of the usage profile fingerprinting system.

20. The method of claim 19, wherein the configuration status information related to the plurality of information handling resources is stored in a configuration management database (CMDB).
